(19) United States
(12) Patent Application Publication
(10) Pub. No.: US 2025/0209210 A1
(43) Pub. Date: Jun. 26, 2025

(54) SYSTEM AND METHOD TO PROVIDE EVIDENCE OF OWNERSHIP OF A DIGITAL DOCUMENT

(71) Applicant: Telefonaktiebolaget LM Ericsson (publ), Stockholm (SE)

(72) Inventors: Dmitry KNYAGININ, Göteborg (SE); Alexander HUNT, Tygelsjö (SE); Bernard SMEETS, Dalby (SE); Tommy ARNGREN, Södra Sunderbyn (SE)

(21) Appl. No.: 18/846,471

(22) PCT Filed: Mar. 23, 2022
(86) PCT No.: PCT/EP2022/057696

§ 371 Date: Sep. 12, 2024

(51) Int. Cl. G06F 21/64; G06F 11/30; G06F 21/32

(52) U.S. Cl. CPC G06F 21/64; G06F 11/3058; G06F 21/32; G06F 2221/2151

(57) ABSTRACT

There is provided a method and a system to provide evidence of authorship of a digital document. The method includes obtaining the digital document. The method further includes acquiring first data and second data, wherein a combination of the first data and the second data provides information to identify an individual, and obtaining a digital timestamp associated to the digital document, the acquired first data and second data together.

### TECHNICAL FIELD

The present invention relates to a method and a system to provide evidence of ownership of a digital document.

### BACKGROUND

Providing evidence of ownership of a document is a long-felt problem. Several solutions to it have been already proposed, ranging from physical signatures and wax seals applied to physical documents to digital signatures applied to digital documents. However, signatures of all types have the drawbacks that they cannot provide evidence of ownership: they can only prove that a certain person had access to the document at some point in time after its creation and placed a signature on it.

With the increasing number of digital transactions and electronic contracts enabled by the Internet, it is of importance to develop methods to provide evidence of ownership of digital documents. Digital signatures do not, on their own, prove ownership and can moreover be forged by a malicious actor who has intercepted a signed communication or obtained a copy of the signature through carelessness.

A known method of providing evidence of ownership requires a notary to certify that the document was in the possession of the correct person. Solutions in prior art attempt to generalize this technique to digital documents.

For example, a non-fungible token (NFT) can be used to prove ownership. The limitation of NFT is that the alleged owner is represented only by his/her private key and that NFT is by definition public.

As another example, in US 2016/0020909 A1 there is a method of certifying a procedure of signature of an electronic file relating to an agreement between at least two parties, the method comprising providing an electronic file relating to an agreement between at least two parties; and when acceptance data of the agreement is received from at least one party the method further comprises digitally signing the agreement electronic file by generating an electronic fingerprint of said agreement electronic file; creating a certification file comprising at least the agreement electronic file and the generated electronic fingerprint of said agreement electronic file; processing at least the certification file. This method provides a way of certifying that a particular document was signed at a particular time but does not provide a means to identify the individuals signing the document.

It is of interest to develop methods to provide evidence of ownership which are zero-trust. Furthermore, it is of interest to develop methods which are asynchronous. In this way, the verification of the ownership may be relatively simple. A digital document may be created at any time and the identity of the person who wishes to verify ownership, called in the following “verifier”, may not be known when the owner of the document interacts with it. Therefore, any method which requires the owner and verifier to pre-register has limitations, because the identity of the verifier may not be known. Further, any method which requires the identity of either the owner or the verifier, or of both, to have their identity verified by a trusted third party may not be feasible because the owner and the identifier may not be available at the same time. It is also of interest to develop methods to provide evidence of ownership where the evidence is not disclosed to the public but given only to a requester.

### SUMMARY

An object of the invention herein described is to provide a system and method to provide evidence of ownership of a digital document.

According to a first aspect of the invention, there is presented a method to provide evidence of ownership of a digital document. The method includes obtaining the digital document, acquiring first data and second data wherein a combination of the first data and the second data provides information to identify an individual. The method includes obtaining a digital timestamp associated to the digital document, the acquired first data and second data.

The first data and second data identifying the individual and the document are “connected together” by the digital timestamp. Therefore, a link between the identifying first data and second data and the digital document is made, both bearing the same timestamp. Evidence is thus provided, that an individual, who can be identified by the combination of the first data and second data, at a given point in time (identified by the digital timestamp) had access to (or “owned”) a certain digital document. Moreover, this method does not require the individual to preregister before creating the digital timestamp.

An embodiment of the first aspect may further comprise storing the digital timestamp and the digital document, first data and second data.

Ownership of the digital document may be verified at any time, just by storing the first data and second data, used to verify the identity of the individual, and the digital document, all with the same timestamp.

In embodiments of the first aspect, the first data or the second data comprise one or more of: a biometric characteristic of the individual or of a third party, a physiological characteristic of the individual or of a third party, a physical characteristic of the individual or of a third party, a characteristic of an act of creating the digital document, a location of the individual or of a third party, or a characteristic of an environment where the individual or of a third party is located.

The first data or the second data are used in combination to verify the identity a particular individual or of a third party. Several characteristics of the individual or of a third party or of the environment where the individual or of a third party is located can be used for this purpose. A great flexibility is thus present. The third party can be used as a witness to provide evidence of the identity of the individual.

In an embodiment of the first aspect, the first data or the second data are acquired while the individual creates the digital document.

Evidence supporting that an individual partook in the creation of the document may be therefore gathered as well. Furthermore, the first data or the second data may be used as well to strengthen the evidence provided by the timestamp that at a given time (and date) the individual had access to the digital document.

In an embodiment of the first aspect, obtaining the digital document includes obtaining partial portions of the digital document in a time sequence.

An individual can provide evidence of having at least a portion of the digital document in their possession at given times during the creation process. This may help in providing the evidence of authorship of the digital document.

In embodiments of the first aspect, obtaining a digital timestamp associated to the digital document, the acquired first data and second data comprises obtaining a trusted timestamp associated to the digital document, the acquired first data and second data.

The time and date at which the first data and the second data were timestamped together with the digital document may be trusted to a greater degree than without a trusted timestamp.

In embodiments of the first aspect, obtaining a digital timestamp associated to the digital document, the acquired first data and second data includes calculating a first hash value by inputting a the digital document, the first data and the second data to a hash function; and obtaining a timestamp of the calculated first hash value.

Due to the characteristics of a hash function, it is extremely difficult to create a further, different, digital document, first data or second data than those used to obtain the first hash value so that the same hash value as the first hash value is obtained. A good confidence can be achieved that the digital document, first data, and second data have not been modified after the timestamp was acquired. In this embodiment, the association between the timestamp and the digital document, first data, and second data is performed via the first hash value.

In embodiments of the first aspect, obtaining a digital timestamp of the calculated first hash value includes sending the calculated first hash value to a Time Stamping Authority and receiving a trusted timestamp of the first hash value from the Time Stamping Authority.

The digital timestamp is created by a trusted third party. Furthermore, no sensitive data are sent to the trusted third party: only the first hash value is transmitted and not the original digital document, the first data, or the second data.

In embodiments of the first aspect, obtaining a digital timestamp associated to the digital document, the acquired first data and second data includes obtaining a digital timestamp associated to the digital document, the acquired first data and second data by means of a blockchain.

If a blockchain is used, no third party for obtaining a trusted timestamp is involved.

In an embodiment of the first aspect, obtaining a digital timestamp associated to the digital document, the acquired first data and second data by means of a blockchain includes calculating a first hash value by inputting the digital document, the first data and the second data to a hash function; and using the first hash value as a part of a block in a blockchain.

The timestamp is obtained using the characteristics of a blockchain. Furthermore, no sensitive data are sent to a third party: only the first hash value is transmitted and not the original digital document, the first data, or the second data.

In embodiments of the first aspect, the first data or the second data are encrypted. In further embodiments, the first data, second data and the digital documents are encrypted.

Enhanced security is achieved: if encrypted, the first data or the second data are more difficult to modify by a malicious entity. The encryption restricts the number of people who can read the first data, second data and the digital document (if also encrypted). Privacy may be thus achieved.

In some embodiments of the first aspect, the first data and the second data are encrypted using a private key of the individual or of a third party.

Cryptography can be used as an additional authentication method since the private key used to perform the encryption is generally in possession of the alleged owner of the digital document or of the first data and second data. Alternatively or in addition, the private key used to perform the encryption may be in possession of a third party who can corroborate the identity of the individual.

Further evidence of ownership is thus provided, due to the fact that the individual demonstrates that they were in possession not only of the digital document, but also of the first data and the second data (the individual needs to have the first data or second data in order to encrypt them). Further, using a private key, the first data, the second data, and the digital document (if encrypted) are difficult to modify by a malicious entity.

In some embodiments of the first aspect, acquiring first or second data relating to a biometric characteristic of the individual includes one or more of: acquiring geometric features of a body part of an individual, acquiring acoustic data relative to reflection of acoustic waves on a body part of the individual, or acquiring the heat pattern of a body part of the individual.

In some embodiments of the first aspect, acquiring first data or second data relating to a physiological characteristic of the individual includes one or more of: acquiring a heartbeat signal of the individual, recording a voice signal of the individual, recording a video of the individual, recording a characteristic of the typing pattern of the individual, recording pressure pattern of a display of an electronic device used by the individual, recording movement pattern on a display of an electronic device used by the individual, or acquiring data relative to the body odor of the individual.

In some embodiments of the first aspect, acquiring first data or second data relating to a physical characteristic of the individual includes one or more of: acquiring an eye color of the individual; acquiring a height of the individual; acquiring a skin color of the individual; acquiring a shape of a body part of the individual.

In some embodiments of the first aspect, acquiring first data or second data relating to an act of creating the digital document includes, while the individual is creating the digital document, one or more of: measuring an applied force by a body part of the individual; measuring the orientation of a body part of the individual; sensing a keystroke of the individual; tracking a movement of the individual; measuring the relative locations of at least two body parts of the individual; tracking an eye movement of the individual.

As already mentioned, the first data or second data can be of very different types, as long as the combination of the first data and second data identifies the individual.

According to a second aspect of the invention, a method to verify ownership of a digital document is provided. The digital evidence of ownership is provided according to the method of the first aspect—The method to verify ownership comprises: obtaining the digital document, the first data, the second data and the digital timestamp; verifying the digital timestamp of the digital document, first data, and second data; and, if the digital timestamp is valid, inspecting the first data and second data to determine the identity of the individual.

A verifier may verify the ownership of a digital document without requiring the owner to pre-register in a database or rely on an external trusted third party to verify the identity of the individual.

In some embodiments of the second aspect, the method further comprises the step of comparing the determined identity of the individual with any characteristic of the individual.

The verifier may confirm that the characteristic of the individual identifies the same individual which is identified by the first data or the second data.

According to a third aspect of the invention, there is a system to provide evidence of ownership of a document, the system comprising a processor and a memory, said memory containing instructions executable by said processor, whereby the system is operative to obtaining the digital document, acquiring first data and second data, wherein a combination of the first data and the second data provides information to identify an individual, and obtaining a digital timestamp associated to the digital document and the acquired first data and second data.

In some embodiments of the third aspect, the system comprises a first sensor adapted to acquire the first data.

In some embodiments of the third aspect, the system comprises a second sensor adapted to acquire the second data.

In some embodiments of the third aspect, the system is operative to obtain a trusted timestamp associated to the digital document and the acquired first data and second data.

In some embodiments of the third aspect, the system is operative to perform the method according to any embodiment of the first aspect. Hereby is achieved all the benefits of the embodiments of the first aspect.

In some embodiments of the third aspect, the first sensor or the second sensor comprises one or more of: an image sensor; a scanner; a lidar; a radar; an ultrasound sensor; an electronic device; an accelerometer; a speaker; a microphone; an inertial measurement unit; a global navigation satellite system receiver; a pressure sensor; a biometric sensor; a smart ring; a smart watch; a haptic sensor; a haptic actuator; a light sensor; a thermal sensor; a gyroscope; a stretch sensor; a strain gauge.

According to a fourth aspect of the invention, there is a computer program comprising instructions which, when executed on a processor, cause the processor to carry out the method of the first aspect.

According to a fifth aspect of the invention, there is a computer program product comprising non-transitory computer readable media having stored thereon a computer program according to the fourth aspect.

BRIEF DESCRIPTION OF THE DRAWINGS The inventive concept will now be described more fully with non-limiting reference to the accompanying drawings in which certain embodiments of the inventive concept are shown.

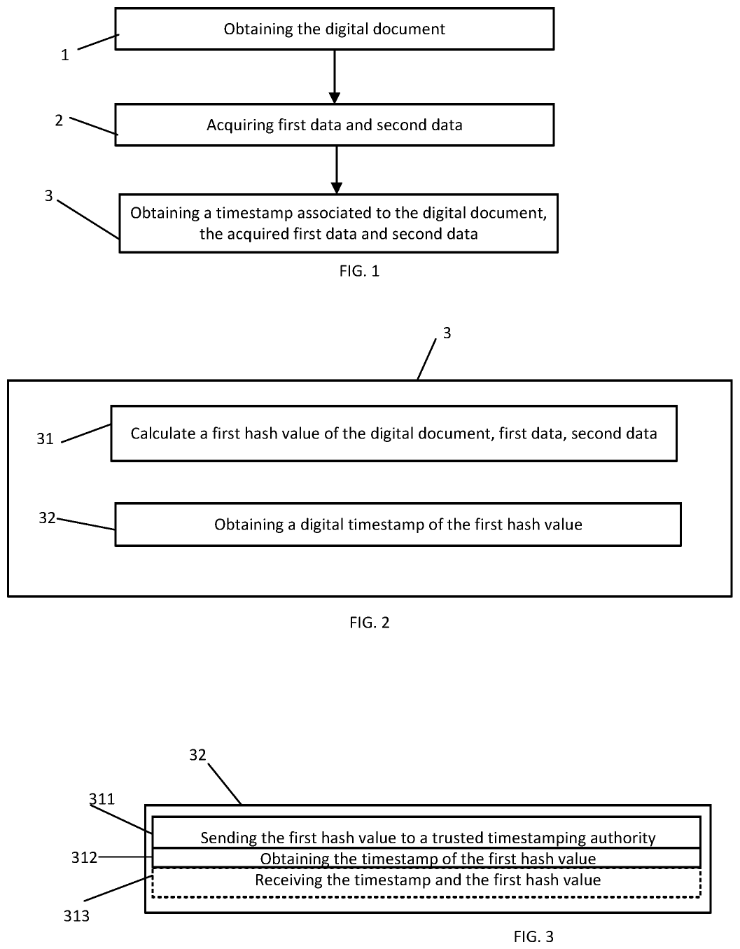

FIG. 1 is a flowchart of a first embodiment of the method according to the first aspect of the invention.

FIG. 2 is a flowchart of an embodiment of an operation of the method of FIG. 1.

FIG. 3 is a flowchart of an embodiment of an operation of the method of FIG. 2.

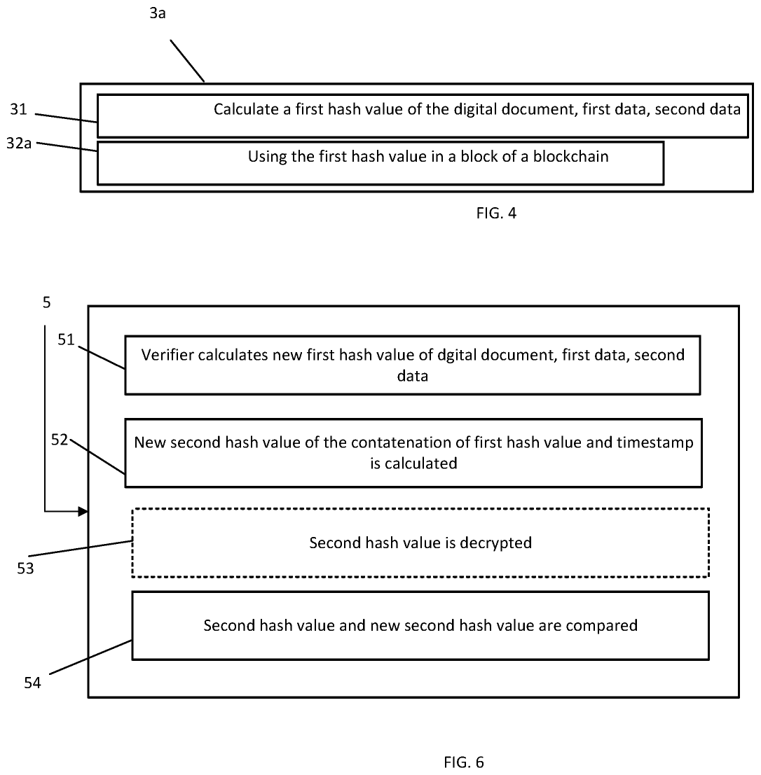

FIG. 4 is a flowchart of a further embodiment, alternative to FIG. 3, of an operation of the method of FIG. 2.

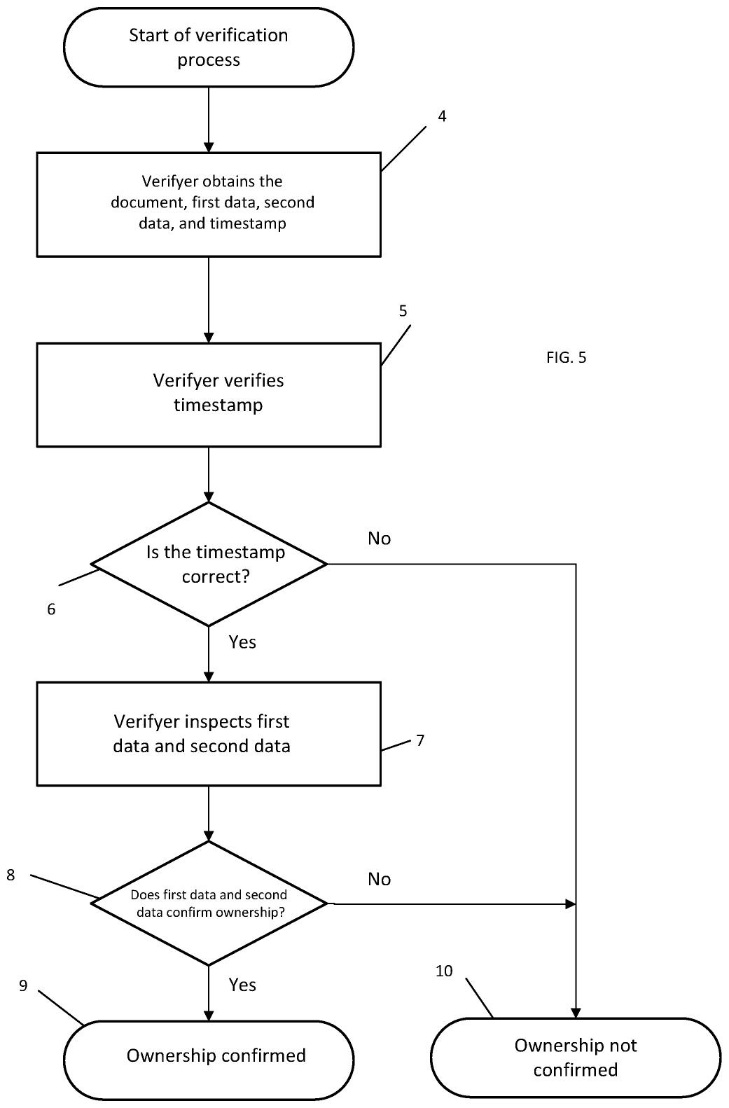

FIG. 5 is a flowchart of an embodiment of the method according to the second aspect of the invention.

FIG. 6 is a flowchart of an embodiment of an operation of the method of FIG. 5.

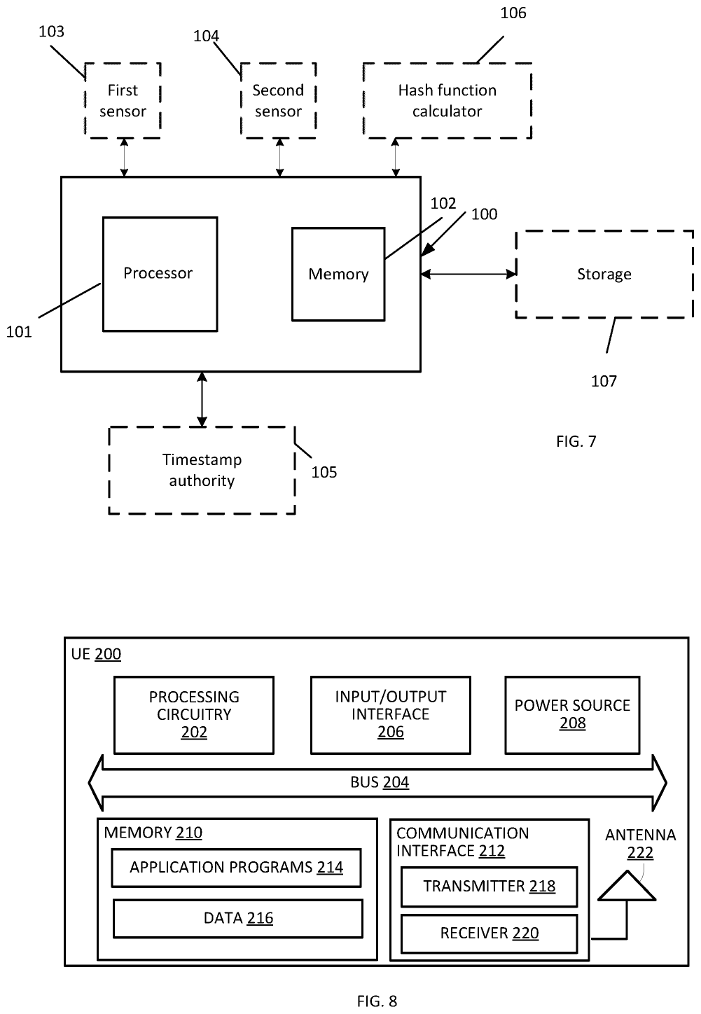

FIG. 7 is a schematic view of the system according to the third aspect of the invention.

FIG. 8 is an embodiment of the system of FIG. 7.

### DETAILED DESCRIPTION

In FIG. 1, a flowchart of an embodiment of the method according to the present invention is depicted. The method aims to provide evidence of ownership of a digital document.

With “timestamp” a sequence of characters or encoded information identifying when a certain event occurred, usually giving date and time of day, is meant. The timestamp includes digital date and time information. The information is then attached to digital data. “Trusted timestamp” adds security to the timestamp. Security in this context means that no one—not even the owner of the document—is “in principle” able to change it once it has been recorded (i.e., timestamped) provided that the timestamper's integrity is never compromised. According to the RFC 3161 standard, a trusted timestamp is a timestamp issued by a Trusted Third Party (TTP) acting as a Time Stamping Authority (TSA).

Furthermore, with “time” a point of time is meant, for example as measured in hours and minutes and a date measured in day, month and year is meant, or measured in any other way as long as the above mentioned information can be obtained.

“Evidence of ownership” of a digital document in the following means that some evidence is provided that on a certain time an individual—the identity of whom can be verified—was provided with, or is in possession of, a given digital document. Although the method of the invention provides reliable evidence, the method does not provide evidence above any reasonable doubt. As it is well known, there is always the possibility of hacking or manipulating evidence, which is not foreseeable or unavoidable, even if the best security procedures are used. Therefore, the method of the invention provides reliable evidence of ownership of a digital document, however eventual frauds are still possible.

Evidence of ownership by a single individual can be provided, however also evidence of ownership by several individuals (i.e., more than one individual) can be provided by the method of the invention.

An individual is any person who is identifiable by any means. Identification of an individual using information means that it is possible to associate the information to a specific (e.g., unique) individual. Given the information, it is possible to select among all individuals a single one who can be directly linked to the information, i.e., a single selected individual—wherein the selection is made using the information—is identified. This link which is possible between the information and the specific individual is the identification of the individual. Therefore, an identification of an individual using information can be done in many different ways. Identification of an individual using information means the information are enough to make a direct link to a unique individual. Many different types of information may lead to the identification of an individual. The individual can be identified for example by information containing the unique morphology of a body part of the individual. For example, the identification may be performed using a physical characteristic of the individual, such as fingerprints or other specific portion of anatomy (i.e., structure of the retina, facial configuration, vein pattern, etc.). As an alternative or in addition, identification may be performed using information related to performing a task. For example, each individual has a specific way of performing a task that is individual-specific. For example, in the act of typing a document, such as a page of the same, each individual has a specific way of pressing keys of a keyboard. The pressing for example has a given frequency and individual-specific pauses between a stroke and the following one are performed. The same applies to an action of signing: the individual has a specific way of moving the hands, angling the bones of the hands while signing and the pressure exerted on the support where the signature takes place. The information that allows the identification of an individual can relate to the environment where the individual is, for example information that identify a unique location and time. Furthermore, the individual may be identified by a third party, i.e., a “witness”. For example, evidence can be provided that the witness was present in the same location as the individual, so that the witness could testify the individual's presence and/or activity. Therefore, the identification can be performed acquiring data of a third party and relating the third party location with a location of the individual.

In case the method relates to the evidence of ownership by several individuals, each of the individuals is identified as above. The first data and second data acquired by the system and method may include data of more than one individual at the same time.

The digital document may be one of many types. The digital document can be a file containing text, for example written in any word editor. Examples include a financial document, an examination, a vote, a legal document such as a contract, a creative work like a book or an article. The digital document may be a sound recording, for example a digital document containing a recording of a voice, of music, of a movie, of recited poetry, etc. The digital document may include an image. The image can be a photograph, a scan of a paper document, a medical record (for example an X-ray or other image of the human body). The digital document may include a video, for example of a creation of an original work (a statue, a painting, etc.) in its phases. The digital document may include a single file or a plurality of files. The content of the digital document can be any. The format of the digital document can be any. The digital document may be encrypted or unencrypted. The digital document may be digitally signed.

Further, the digital document may be in any format. The digital document may be encoded, if needed.

The digital document can be created in many different ways. In case of text, it can be written using a keyboard in a standard computer, laptop, tablet. It can be written using a writing tool (e.g. pen, pencil, marker, etc.) on a piece of paper that is then scanned. The text may be written on a touch sensitive screen. The text may be written using a smart pen, an active or inactive stylus, or a finger, or any other device capable of activating the touch sensitive screen. In case of an image, the image may be collected using a suitable sensor, such as a camera and the like. The sensor (e.g., the camera) in turn may be part of a wireless device, such as an electronic device. The sound may be recorded by a suitable microphone. An image can also be created using an artistic tool on a touch sensitive screen. In an embodiment, the digital document may be created using first electronic device, further detailed below.

As depicted in FIG. 1, the method includes, in operation 1, obtaining a digital document. The digital document is as defined above. The digital document may be obtained in any way, for example via a wired or wireless communication. In an embodiment, obtaining the digital document may include receiving the digital document. Alternatively or in addition, the digital document may be already available and therefore no transmission of data to obtain the digital document may be needed. In an embodiment, obtaining the digital document may include retrieving the digital document.

In addition to the digital document, according to the method, also a first data and second data are acquired, in operation 2. The first data and second data are acquired using for example suitable sensors. The first data and second data may be acquired while the digital document is created or they can be acquired independently to the digital document creation. First data and second data are such that, when combined, they provide information to identify an individual. First data and second data may be independent of each other. First and second data for example can be collected by different sensors. First data and second data may be collected at the same time, or at different times. First data and second data may be collected in the same location or in different locations. The acquisition of the first data and second data may be obtained by a reception of the first data and second data via a transmission channel. The transmission channel may be wired or wireless.

The first data or second data may relate to a characteristic or a parameter of the individual. For example, the first data or second data may provide information related to one or more of biometric, physical, or physiological characteristics or parameters of the individual. Alternatively or in addition, the first data or second data may provide information related to one or more characteristics or parameters of an activity that the individual may be performing. In this case, the first data or second data are acquired while the individual is performing the activity, such as the activity of creating the digital document. Some of the first data or second data may provide information related to a third party, who can be used as a witness and who can provide evidence (for example by means of a testimony) of the identity of the individual. For example, the first data or second data may provide information related to one or more of biometric, physical, or physiological characteristics or parameters of the third party, to identify the third party who in turn may identify the individual.

The first data or second data may provide information related to an environment where the individual is located. The first data or the second data may provide information related to one or more parameters or characteristics of the environment. The parameter or characteristic may include the temperature, the weather condition, etc. The first data or second data may provide information related to an environment where the third party is located. The first data or the second data may provide information related to one or more parameters or characteristics of the environment. The parameter or characteristic may include the temperature, the weather condition, etc. Preferably, the first data or second data may provide information related to a location of the individual and a location of the third party, so that the location of the individual and the location of the third party can be compared. The first data or the second data may include a single data point, such as information related to a location of the individual, for example at the time the document creation is started, or it may include multiple discrete data points, such as sampling the voice of the individual at certain points of time, for example taken during the creation of the document. The first data or the second may further include metadata, such as a geotag. As an example, the first data or second data may be continuously collected during the creation of the document, such as data relating to the keystrokes on the individual's keyboard during the entire creation of the document.

It will be evident to the person skilled in the art that first data and second data may be collected for more than one author, in the case where a document is owned by several individuals.

The first data and second data together provide information to identify the individual. The combination of the first and the second data, for example the use of the first and second data together, allows the identification of the individual. If evidence of ownership by several individuals is requested, then the first data and the second data together provide information so that all individuals can be identified. Each of the first data and second data may relate to one or more of the individuals.

First data or second data may be acquired by means of a second electronic device. The second electronic device may be the same electronic device used for creating the digital document, i.e., the first electronic device and the second electronic device are the same device, or a different electronic device. The first electronic device or the second electronic device, or both, may include a user equipment, UE. First data or second data may be acquired using the UE. Alternatively or in addition, the digital document can be created using the same UE. Using the same electronic device, e.g., the same UE, to acquire first data and second data and at the same time creating the digital document may simplify the process. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

An embodiment of the UE 200 is depicted in FIG. 8. The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a keyboard, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device. The input device, the output device or the sensor may be used to acquire the first data or the second data. The input device, the output device or the sensor may be used to acquire the first data and the second data. The input device, the output device or the sensor may be used to create the digital document by the individual.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may or may not be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, a web browser application, a widget, a gadget engine, or other application, and corresponding data 216. The memory 210 may store, for use by the UE 200, any of a variety of operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global navigation satellite system (GNSS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user-initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In an embodiment, the method comprises collecting first data relative to a physical or physiological characteristic of the individual and second data relative to the individual interacting with the document. Moreover, the first data and the second data both comprise information allowing the verifier to verify that the first data and the second data are collected in the same location.

In an embodiment, the first data is relative to the individual's face: it may for example comprise a photograph, a video recording, or geometric data relative to the individual's face. In an embodiment, the second data is collected from an input device used to create the digital document by the individual. This second data may comprise input data from a keyboard, a smart pen, a touch screen belonging to an electronic device, a voice recording or any other way to input information to an electronic device. Moreover, both the first data and the second data may comprise information associated with a geographic position, for example by means of a geotag.

First data or second data may include metadata as well. For example, first data or second data may include a photograph as well as information on the camera with which the photograph was taken, such as the type of lens.

In embodiments, the first data comprise acoustic data relative to reflection of acoustic waves on a body part of the individual. In particular, this first data may be relative to reflection of acoustic waves on the inner ear of the user.

In embodiments, the first data comprise a fingerprint of the individual. In another embodiment, the first data comprise a retinal scan of the individual.

In embodiments, the first data or the second data include data acquired detecting a motion pattern, or a body posture (sitting, standing, etc.) of the individual while creating the digital document.

In embodiments, first data or second data may include the data acquired detecting one or more objects in a field of view (FOV) of a sensor.

The method further includes obtaining a digital timestamp associated to the digital document, the first data, and the second data in operation 3. A single timestamp is associated to a group comprising the digital document, first data, and second data. Therefore, the first data, second data, and digital document are all linked to the same timestamp. The association may be performed for example by using the digital document, first data and second data as inputs to a function. The function may be the identity function. The function may be a mathematical function applied to the group comprising the first data, second data, and digital document transforming the group in transformed data. Transformed data may be an alphanumerical value.

In some embodiments, the function is a hash function. As depicted in FIG. 2, the operation 3 of obtaining a digital timestamp associated to the digital document, the first data, and the second data may include operation 31. In operation 31, a first hash value is calculated by inputting the digital document, the first data, and the second data to a hash function. The operation 3 of obtaining a digital timestamp associated to the digital document, the first data, and the second data may also include operation 32. In operation 32, a timestamp of the first hash value is obtained.

A hash function is a mathematical function that converts a numerical input value into another compressed numerical value. In this case, the inputs of the hash function are the digital document, the first data and the second data. The input to the hash function is of arbitrary length but output is always of fixed length. A value returned by a hash function is called hash value.

Due to the pre-image resistance of the hash function, if a hash function h produced a hash value z, then it is a difficult process to find any input value x that hashes to z. This property protects against an attacker who only has a hash value and is trying to find the input. The hash function also has collision resistance. This property means it should be hard to find two different inputs of any length that result in the same hash. This property is also referred to as collision free hash function.

In order to obtain a digital timestamp of the hash value, the method of FIG. 3 may be used. Operation 32 may include operation 311 where the first hash value is sent to a Trusted Timestamp Authority. A trusted Timestamp Authority (or TSA) can issue secure (trusted) timestamps. The trusted timestamp is preferably compliant with RFC 3161 and RFC 5816.

The TSA concatenates a timestamp to the first hash value (operation 312). The TSA may also calculate a second hash value of this concatenation. Preferably, the same hash function used to calculate the first hash value is used. This second hash value may be in turn digitally signed with the private key of the TSA. Operation 32 may include operations where the second hash value and the timestamp are obtained. The TSA then sends back the timestamp in operation 313. For example, the TSA may also send back the second hash value.

Preferably, the method of the invention also includes the operation (not depicted) of storing the second hash value, the timestamp, and the group of first document, first data, second data.

The document, the first data, and the second data may be encrypted before obtaining the timestamp. In some embodiments, this encryption is performed by a private key belonging to the author or a private key belonging to the third party.

In a different embodiment of operation 3, called operation 3a, the obtaining a digital timestamp associated to the digital document, the acquired first data and second data includes: obtaining the digital timestamp associated to the digital document, the acquired first data and second data by means of a blockchain. In this embodiment, as depicted in FIG. 4, operation 3a includes operation 31 and 32a: Operation 31 is the same operation as described with reference to FIG. 3, while operation 32a includes using the first hash value as a block in a blockchain. For example, the first hash value which has been calculated in operation 31 is incorporated in a transaction stored in a blockchain. The first hash value therefore is a part of a block of a blockchain in operation 32a. The blockchain then serves as evidence that the hash value was not calculated at a later time.

In some embodiments, the document, the first data, and the second data may be stored in a suitable memory. The document, the first data, and the second data may for example be stored in local storage in a computer belonging to the individual, in the UE 200 belonging to the individual, in an external memory such as an external hard drive or a USB stick, or in a cloud service available to the individual.

The method may further comprise storing the timestamp.

In FIG. 5, there is provided a method for verifying the ownership of a digital document where evidence has been collected according to an embodiment of the invention. The evidence is provided for example by a “purported individual” claiming to be the owner of the digital document. The verification is performed by a verifier. The verifier may for example be a further individual, a network node, a standalone computer, a user equipment, UE, or a distributed computing system. The evidence of ownership has been provided according to the method of any of the previous embodiments, for example the embodiment depicted in FIG. 1. When a verifier wishes to verify the ownership of a digital document, the verifier first obtains the digital document, the first data, the second data, and the timestamp in operation 4. The verifier may obtain also the first hash value or the second hash value, or both, if applicable. If the digital document, first data, or second data was collected according to an embodiment which includes encrypting the digital document, the first data, and the second data, the verifier is also given access to the public key of the individual.

The verifier will first verify the digital timestamp of the digital document, first data and second data in operation 5, to check whether it is correct (operation 6). This is achieved, for example, through either a timestamp verification method laid out by the TSA, or by verifying the integrity of the blockchain. If the digital document, the first data, and the second data are associated in the blockchain to a first hash value, the verifier may verify that using the digital document, the first data, and the second data as inputs to the hash function produces the first hash value stored in the blockchain.

A method to verify the timestamp as in operation 5 may be as depicted in FIG. 6. In this case, the first hash value and the second hash value have been provided, according to the method of the embodiment of FIG. 3. A new first hash value of the digital document, first data and second data is calculated in operation 51 using the same hash function (i.e., for example the one used by the TSA).

The timestamp given by the TSA is appended to it and a new second hash value of the result of this concatenation is calculated, called new second hash value, in operation 52.

The new second hash value is compared to the second hash value in the hands of the verifier in operation 53. If the second hash value and the new second hash value are identical, then the timestamp is verified.

In case the digital signature of the TSA was applied to the second hash value, then the digital signature of the TSA needs to be validated as well. This is done in operation 54 by decrypting the digital signature using public key of TSA, producing the second hash value. As before, the new second hash value is then compared with the second hash value inside the signed TSA message to confirm they are equal, proving that the timestamp and message is unaltered and was issued by the TSA. If not, then either the timestamp was altered or the timestamp was not issued by the TSA.

If the timestamp is not verified, e.g., the new second hash value and the second hash value are not identical, the verifier can reject the presented evidence as a possible forgery (operation 10).

Moving back to FIG. 5, if the digital timestamp is correct (e.g., it is verified), the verifier inspects the first data and second data to determine an identity of the individual. In order to perform this operation, the verifier accesses the first data and the second data in operation 7. The verifier uses the first data and the second data to determine the identity of the individual. First data and second data are sufficient to determine the identity of the individual. The identity of the individual as determined by the first data and second data may then be compared to the identity of the “purported individual” claiming to be the owner of the digital document. The identity of the purported individual is verified using a characteristic of the individual. If the first data and second data confirm ownership (operation 8), e.g., if the two identities coincide, then the ownership of the digital document by the purported individual is confirmed (operation 9).

Operation 8 may be fully automatic. For example, if the identity of the individual is verified by an image of the face of the individual acquired in the first data or the second data, then the identity of the purported individual and the one of the individual identified by the first data and second data can be compared by for example running a facial recognition algorithm on the purported individual and comparing it with the image acquired in the first data and second data. Operation 8 may be fully manual, by for example letting the human verifier compare the image of the individual with the face of the purported individual. Operation 8 may be a mix between an automatic and a manual process. The first data and the second data may be processed differently.

If the comparison with the characteristic of the purported individual indicates that he/she is not the individual as identified by the first data and second data, then the ownership claim may be rejected. If the comparison with the characteristic of the purported individual indicates that the purported individual is the individual identified by the first data and the second data, then ownership is confirmed. The level of certainty of this ownership confirmation may depend on the nature of the first data and the second data, possibly in relation to the type of digital document, to what extent the timestamp may be trusted, and the certainty level of the method by which the first data and the second data were processed.

In FIG. 7, a system adapted to providing evidence of ownership of a digital document is depicted and globally indicated as 100. The system 100 comprises a processor 101, and a memory 102 having stored thereupon instructions executable by the processor.

The system 100 may include a laptop, a computer, a network node, a user equipment 200, or a distributed computing system.

The processor 101 may comprise fixed circuitry or programmatically configured circuitry or a mix of both. For example, the system includes one or more microprocessors, Digital Signal Processors (DSPs), Application Specific Integrated Circuits (ASICs), Field Programmable Gate Arrays (FPGAs), Complex Programmable Logic Devices (CPLDs), or other arrangement of digital processing circuitry. In at least one embodiment, the processor is realized based on the execution of stored computer program instructions. Processor 101 may be processing circuitry 202 of UE 200.

For example, the processor 101 comprises one or more microprocessors that are specially adapted to carry out the operations attributed herein to the processor, based on the execution of computer program instructions from one or more computer programs stored in the memory of the system. To this end, the memory may comprise more than one type of memory or more than one memory device. More broadly, the memory may comprise one or more storage devices and may include more than one type of storage device, such as volatile and non-volatile memory devices.

When executed by the processor(s), the instructions cause the system to become operative in accordance with any of the embodiments of the invention described above with reference to FIGS. 1-6.

The memory 102 may, e.g., be a Random-Access Memory (RAM), a Read-Only Memory (ROM), a Flash memory, or the like. The computer program may be downloaded to the memory by means of a network interface circuitry which may be comprised in the system, as a data carrier signal carrying the computer program. Memory 102 may be memory 210 of UE 200.

The system 100 may comprise a first sensor 103 and a second sensor 104. The processor 101 in at least one embodiment is configured to receive first data and second data from the first sensor and the second sensor, wherein a combination of the first data and the second data provides information sufficient to identify the individual.

Different sensors can be used to collect evidence of ownership of a digital document. The first sensor 103 and the second sensor 104 can have the same or different modalities.

The first sensor 103 or the second sensor 104 sensors may be, for example, a camera, a scanner, a user equipment, an accelerometer, a sound generator, a microphone, a GNSS receiver, an inertial measurement unit, a pressure sensor, a biosensor, a haptic sensor, a light sensor, a LiDAR sensor, a radar sensor, an ultrasonic sensor, an electronic nose, a medical device for monitoring vital signs, a capacitance tracker, or an induction tracker.

In embodiments, the first sensor 103 or the second sensor 104 may comprise a camera. The camera may be positioned in a head mounted device. The camera may be mounted on a computer or other UE used to create the digital document. The camera may be located anywhere where it is operable to collect first data or second data which may be used to identify the owner of the digital document. The camera may be configured to take a photograph or a video recording. It may further be configured to store or transmit the photograph for storage in memory 102. It may further be configured to attach a geotag to the photograph or video. It may further be connected to the processor 101 configured to extract information such as geometric features of the body part of the individual captured by the camera or video. This connection may be wireless or by means of a cable.

The first sensor 103 or the second sensor 104 may be an IMU or part of an IMU such as an accelerometer or a gyroscope or a magnetometer independently. The IMU may be a separate unit or part of a smart device or other UE available to the system. The IMU may communicate the first data or second data it collects wirelessly or over a cable. The data collected by the IMU may be relative to for example the movement of a hand controlling the input method used by the individual. The first data or second data may then later be matched to movement patterns provided by the individual to support their claim of ownership of the digital document.

The first sensor 103 or the second sensor 104 may be adapted to secure information relative to sound waves reflected on a body part of the user. For example, the first sensor 103 or the second sensor 104 may be adapted to emit a sound signal to be reflected off the inner ear of the individual and record the reflected signal.

The first sensor 103 or the second sensor 104 may be adapted to track the movement pattern characteristic of the individual by means of sound acoustic wave technology or ultrasound technology.

The first sensor or the second sensor may comprise a capacitance tracker adapted to track an input device used by the individual or record the movement pattern of the individual on a screen of a device used by the individual. The first data or second data may identify the individual by recording a movement pattern characteristic of the individual, or it may provide supporting evidence that the individual identified by other data interacted with the document. In some embodiments, an induction tracker may be used instead to record the first data or the second data.

The first sensor 103 or the second sensor 104 may be a radar sensor or a lidar sensor. The first sensor 103 or second sensor 104 may be adapted to track movements or gestures of the individual. The first data or second data provided by these sensors may directly identify the individual by recording actions characteristic of the individual, or provide supporting evidence that an individual otherwise identified interacted with the digital document in a specific manner.

The first sensor 103 or the second sensor 104 may comprise a GNSS such as a GPS, GLONASS, Galileo® or BeiDou® receiver. It may be incorporated in another sensor to for example provide other data with a geotag, or it may be provided independently. It may for example be used to verify that a device belonging to the individual was located in a particular location at a given time.

The first sensor 103 or the second sensor 104 may comprise a biometric sensor. For example, the biometric sensor may be a retinal scanner, a fingerprint scanner, or an artificial nose. The first data or second data collected by this type of sensor may be used to identify the individual whom the first data or second data was collected from.

In some embodiments of the invention, the system 100 may have integrated first sensor 103 and second sensor 104. For example, first sensor and second sensor may be part of UE 200. In other embodiments, the system may cause for example a smart pen or a pair of smart glasses used by the individual to collect the first data or the second data or both the first data and the second data. The first sensor 103 or second sensors 104 may communicate with the processor 101 over a cable or using a wireless communications protocol such as LTE, 5G, Bluetooth, ZigBee, or any other suitable protocol. The first sensor 103 or second sensor 104 may transmit the raw first data or second data, or it may locally process the data before transmitting it to the processor 101.

The processor 101 in at least one embodiment is configured to receive the digital document.

The first data, the second data or the digital document may be received by the processor 101 for example by means of a network interface circuitry. The network interface circuitry (not depicted in the drawings) may comprise one or more of a cellular modem (e.g., GSM, UMTS, LTE, 5G, or higher generation, including communications solutions dedicated for first responders, emergency personnel, military, law enforcement, etc), a WLAN/Wi-Fi modem, a Bluetooth modem, an Ethernet interface, an optical interface, or the like, for exchanging data between the system 100 and other devices, UEs, an application server, the Internet, etc.

The system 100 may also be connected to an external storage unit 107 to store any of the timestamp, the first data, the second data or the digital document. After collecting the first data, second data, digital document, the system will store the document, the first data, and the second data. The system may cause the document, the first data, and the second data to be stored on memory 102, storage 107 or on a cloud server, or in any other suitable location.

The instructions will then cause the processor to obtain a trusted timestamp for the document, the first data, and the second data together. The timestamp may be a trusted timestamp from a timestamping authority. In other embodiments, the timestamp may be obtained by means of a blockchain. In some embodiments, the instructions first cause the processor to apply a hash function to the document, the first data, and the second data before obtaining the timestamp. In other embodiments, the instructions cause the processor to encrypt the document, the first data, and the second data using a public key of the author before obtaining the timestamp.

The processor 101 in at least one embodiment is configured to create a first hash value of the first data, second data and digital document using a hash function calculator 106.

The processor 101 in at least one embodiment is configured to obtain a timestamp of the digital document and the acquired first data and second data together. The timestamp may be for example obtained by a TSA 105. In any case, the processor is configured to obtain a timestamp according to any method.

An embodiment of the method may be implemented as the computer program comprising instructions which, when the computer program is executed by a computing device, such as the system, cause the system to carry out the method and become operative in accordance with embodiments of the invention described herein. The computer program may be stored in a computer-readable data carrier, such as the memory 102. Alternatively, the computer program may be carried by a data carrier signal, e.g., downloaded to the memory via the network interface circuitry.

The program code mentioned above may also be provided as a computer program product, for instance in the form of a data carrier carrying computer program code for performing the embodiments herein when being loaded into the camera module 300. One such carrier may be in the form of a CD ROM disc. It is however feasible with other data carriers such as a memory stick. The computer program code may furthermore be provided as pure program code on a server and downloaded to the system.

### Example 1

The individual creates a digital document. At least a first sensor 103 and a second sensor 104 record first data and second data, respectively, during the creation process.

For instance, when the individual writes a text on paper, first data or second data can be collected automatically from smart glasses (tracking the act of writing using a camera) worn by the individual. First data or second data can be collected automatically from a smart watch (tracking the act of writing via hand movement using for example an IMU) worn by the individual. First data or second data can be collected automatically from a smart pen (tracking the act of writing and writing pattern) used by the individual. The written document is then digitalized by any known means (e.g. scanning).

Likewise, when the individual types a text on a laptop so that the document is digital from the onset, first data or second data can be collected from the user's smart glasses and the laptop's camera and smart watch (tracking the act of typing). First data and second data can be collected, like the duration of writing, keystrokes per minute, writing patterns, error likelihood etc. Fingerprint sensors can be used for biometric authentication. Other sensors can be used to collect data about the individual's location (e.g., a global position and a map of the individual's environment). Other sensors may be used as well to acquire data. The first sensor 103 or the second sensor 104 may belong to the individual or to another individual or entity.

A single hash is created of the digital document, the first data and the second data.

The single hash is securely timestamped by a timestamping authority such as SSL.com®, Digicert®, Sectigo®, or GlobalSign®.

The individual may store the digital document, the first data, the second data, and the securely timestamped single hash together, e.g., in a private cloud. The access to the private cloud may be protected. A possible protection is for example by using biometrical data of the individual.

This way, there is multi-sensor evidence of not only of ownership, but also of authorship, and the individual with the earliest trusted timestamp can be assumed to be the real author.

### Example 2

In order to verify the ownership of a digital document by an individual, wherein the evidence of ownership has been collected as in Example 1, the following embodiment of the method of the invention may be used.

Access to the digital document, the first data, the second data, and the timestamped hash is given. The timestamp is verified by calculating the hash value of the digital document, the first data, the second data, appending the given timestamp, and calculating the hash value of the resulting number. If this matches the value signed by the timestamp authority, then the timestamp is considered valid. If the timestamp verification fails, the ownership is invalid.

The first data and the second data to assess the evidence of ownership are inspected. This inspection can be performed in different ways depending on the number of sensors and their modalities. If the first data and second data do not support that the individual that claims ownership is the individual which is identified by the first data and second data, the ownership is invalid (the individual claiming to be the owner is not). For example, visual inspection or the output from an algorithm may indicate that the purported author is not the person in a photograph or video recording comprising the first data or the second data. In another case, the geotags collected for the first data and the second data indicate that the first data and the second data were collected in different locations. In another case, data collected from an input device does not match the digital document. Otherwise, the ownership is valid (the individual is the owner of the digital document).

### Example 3

A paper document is signed and then digitalized, for example by scanning it. While the document is signed by the individual, first data and second data are collected by a first sensor and a second sensor. For instance, the conventional way to sign a document is to write a signature, date and place. The date and place can come from first sensor or second sensor and then timestamped in the trusted way (like in Example 1). Likewise, first data or second data like a video recording from a camera in AR glasses can be collected.

In order to verify ownership, the individual has to sign again and the first data and second data acquired while the digital document has been signed are compared with data acquired during the new signature used for verification.

1. A computer-implemented method to provide evidence of ownership of a digital document, the method including:
obtaining the digital document;
acquiring first data and second data, a combination of the first data and the second data providing information to identify an individual; and
obtaining a digital timestamp associated to the digital document, the acquired first data and second data.

2. The method according to claim 1, further comprising:
storing the digital timestamp and the digital document, first data, and second data.

3. The method according to claim 1, wherein the first data or the second data comprise one or more out of:
a biometric characteristic of the individual or of a third party;
a physiological characteristic of the individual or of a third party;
a physical characteristic of the individual or of a third party;
a characteristic of an act of creating the digital document;
a location of the individual or of a third party; and
a characteristic of an environment where the individual or a third party is located.

4. The method according to claim 1, wherein acquiring first data and second data comprises:
acquiring the first data or the second data while the individual creates the digital document.

5. The method according to claim 1, wherein obtaining the digital document includes:
obtaining partial portions of the digital document in a time sequence.

6. The method according to claim 1, wherein obtaining a digital timestamp associated to the digital document, the acquired first data and second data comprises obtaining a trusted digital timestamp associated to the digital document, the acquired first data and second data.

7. The method according to claim 1, wherein obtaining a digital timestamp associated to the digital document, the acquired first data and second data includes:
calculating a first hash value by inputting the digital document, the first data and the second data to a hash function; and
obtaining a digital timestamp of the calculated first hash value.

8. (canceled)

9. The method according to claim 1, wherein obtaining a digital timestamp associated to the digital document, the acquired first data and second data includes:
obtaining the digital timestamp associated to the digital document, the acquired first data and second data by means of a blockchain.

10. (canceled)

11. The method according to claim 1, further comprising:
encrypting the first data and the second data.

12.-17. (canceled)

18. A method to verify ownership of a digital document by an individual, the method comprising:
obtaining the digital document, the first data, the second data, and the digital timestamp;
verifying the digital timestamp associated to the digital document, first data and second data;
if the digital timestamp is verified, inspecting first data and second data to determine an identity of the individual.

19. A system to provide evidence of ownership of a document, the system comprising a processor and a memory, the memory containing instructions executable by the processor to cause the system to:
obtain the digital document;
acquire first data and second data, wherein a combination of the first data and the second data provides information to identify the individual; and
obtain a digital timestamp associated to the digital document, the acquired first data and second data.

20. The system according to claim 19, further comprising:
a first sensor configured to acquire the first data.

21. The system according to claim 19, further comprising a second sensor configured to acquire the second data.

22.-24. (canceled)

25. A non-transitory computer readable medium having stored thereon a computer program comprising instructions which, when executed on a processor, cause the processor to:
obtain the digital document;
acquire first data and second data, a combination of the first data and the second data providing information to identify an individual; and
obtain a digital timestamp associated to the digital document, the acquired first data and second data.
